(19) United States
(12) Patent Application Publication
(10) Pub. No.: US 2007/0108363 A1
(43) Pub. Date: May 17, 2007

(54) Bracket assembly for deck accessories

(76) Inventor: Jack Metheny, West Des Moines, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 11/273,394

(22) Filed: Nov. 14, 2005

(51) Int. Cl. H01Q 1/12

(52) U.S. Cl. 248/539

(57) ABSTRACT

A bracket assembly is provided for mounting a pole of a deck accessory to a deck rail. The bracket assembly includes a first bracket having a channel for receiving the deck rail so as to mounted thereto, without the used of hardware or tools. An insert may be provided in a collar on the first bracket so as to reduce the diameter of the collar, and thereby accommodate poles having different diameters. A lower bracket may be provided with a collar and insert to receive the lower end of a deck accessory pole. The lower bracket is mounted to a block which contacts one or more of the vertical deck posts, without being secured thereto, for aligning the second bracket beneath the first bracket.

### BACKGROUND OF THE INVENTION

Decks on residential homes, cottages and cabins are popular in many parts of the country. Accessories for the decks are also popular, such as umbrella stands, tiki torches, flag poles, canopies, solar lights, grills, and even satellite dishes. Many of these accessories include a pole which is mounted to the floor of the deck or to the deck railing. Various forms of brackets have been used for securing the accessory pole to the deck rail, and usually require clamps, screws or other hardware to secure the bracket to the deck rail. Once mounted, the brackets are fixed and not movable, without leaving unsightly marks and blemishes on the rail from the hardware.

Therefore, a primary objective of the present invention is the provision of an improved bracket assembly for mounting a pole to a deck rail.

Another objective of the present invention is a provision of a bracket assembly which mounts to a deck rail without the use of hardware, so as to support a pole of a deck accessory.

A further objective of the present invention is a provision of a bracket assembly which is slidable along a deck for supporting an accessory pole adjacent the deck rail.

A further objective of the present invention is a provision of a bracket assembly which can be quickly and easily mounted to a deck rail without the use of tools.

Yet another objective of the present invention is a provision of a bracket assembly for a deck rail which accommodates poles having different diameters.

Still another objective of the present invention is a provision of deck rail bracket assembly having interchangeable inserts with varying diameters to hold poles having different diameters.

Another objective of the present invention is a provision of a bracket assembly for a deck rail to hold accessories, wherein the assembly is economical to manufacturer, and durable and safe in use.

These and other objectives that will become apparent from the following description of the invention.

### BRIEF SUMMARY OF THE INVENTION

The bracket assembly of the present invention is intended to hold a pole of a deck accessory such as a tiki torch, umbrella, flag pole, and the like. The assembly includes a first bracket having a channel for slidably receiving the deck rail and being mounted thereto without the use of hardware or tools. The first bracket includes a collar with a hole. One or more inserts are provided for insertion into the collar hole, with each insert having a hole with different diameters. Thus, the pole of a deck accessory can be inserted through the collar, or through a selected insert placed within the collar. The assembly includes a second lower bracket which also has a collar with one or more inserts with varying diameters, so as to accommodate poles having different diameters. The lower bracket is mounted to a block which engages at least one upright post of the deck so as to align the second bracket with the first bracket without the use of hardware or tools.

### BRIEF DESCRIPTION OF THE DRAWINGS

FIG. 1 is partial perspective view of a deck having a tiki torch mounted to the deck rail using the bracket assembly of the present invention.

FIG. 2 is a view similar to FIG. 1 showing an umbrella mounted to the deck rail using the bracket assembly of the present invention.

FIG. 3 is a perspective view of the upper bracket of the bracket assembly.

FIG. 4 is an exploded view of the upper bracket of the bracket assembly.

FIG. 5 is a perspective view of an alternative embodiment of the upper bracket.

FIG. 6 is an exploded view of the alternative bracket shown if FIG. 5.

FIG. 7 is a perspective view of the lower bracket of the bracket assembly.

FIG. 8 is an exploded view of the lower bracket.

FIG. 9 is a view of the lower bracket with an alternative insert positioned therein.

FIG. 10 is an exploded view of the lower bracket shown in FIG. 9.

FIG. 11 is an elevation view of a deck having a canopy connected to the deck rail using the bracket assembly of the present invention.

### DETAILED DESCRIPTION OF THE PREFERRED EMBODIMENT

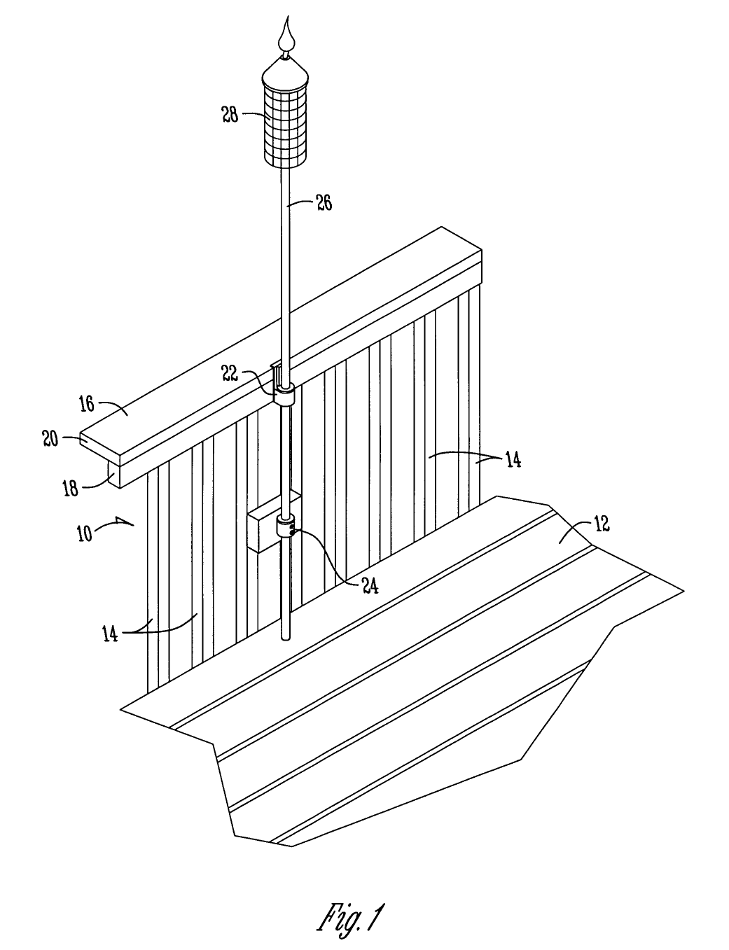

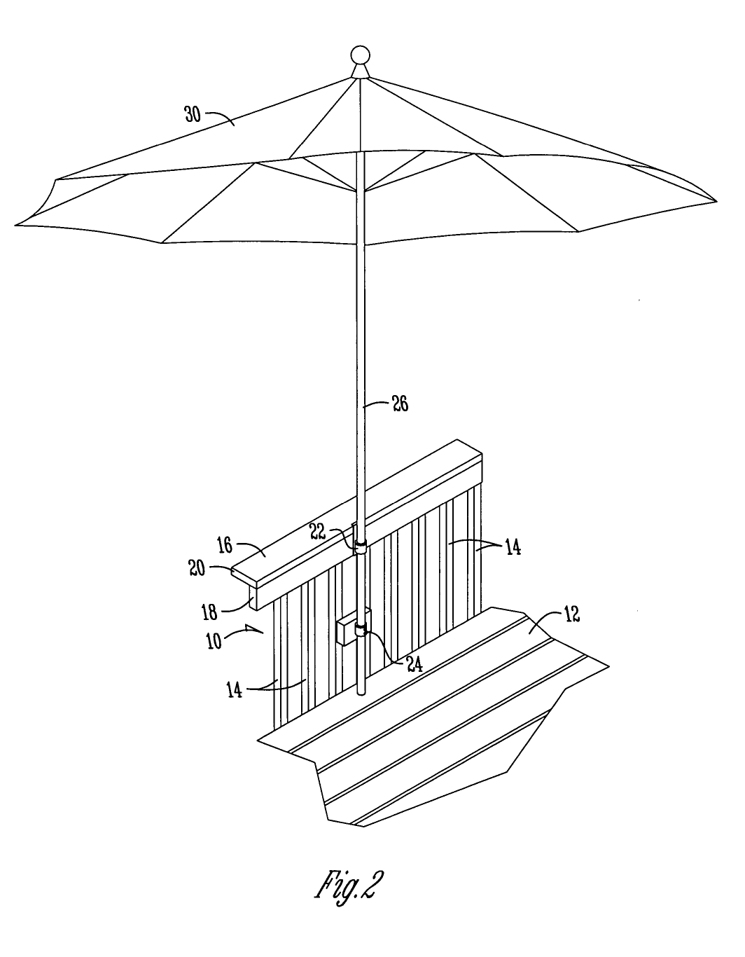

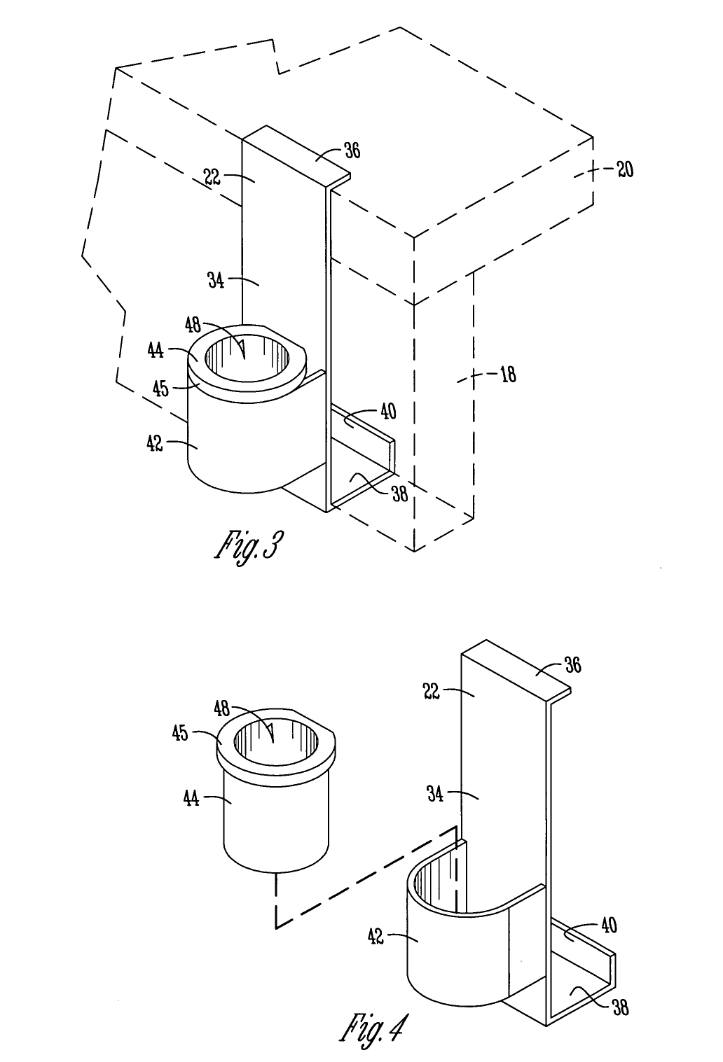

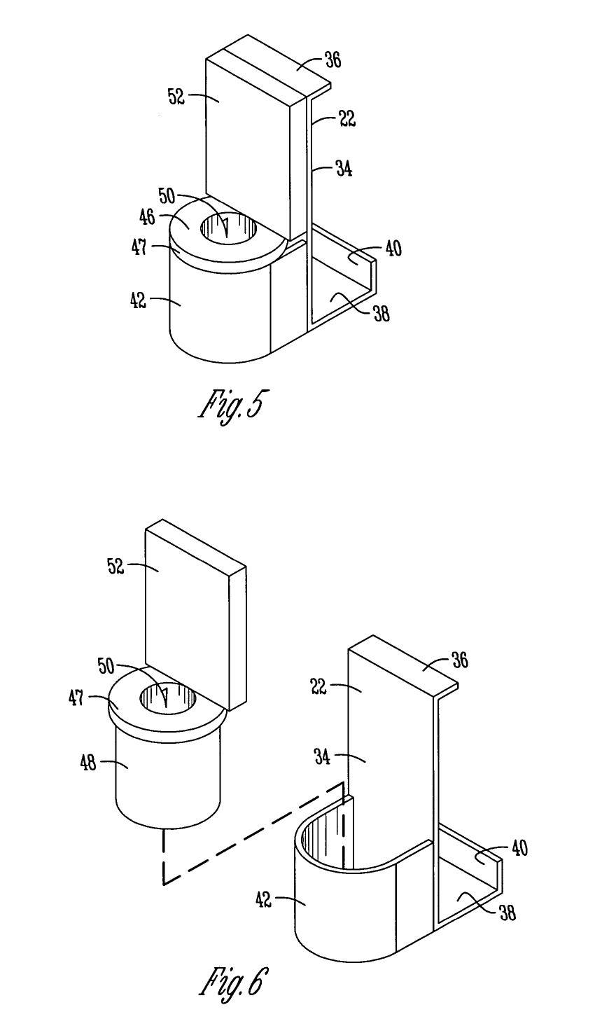

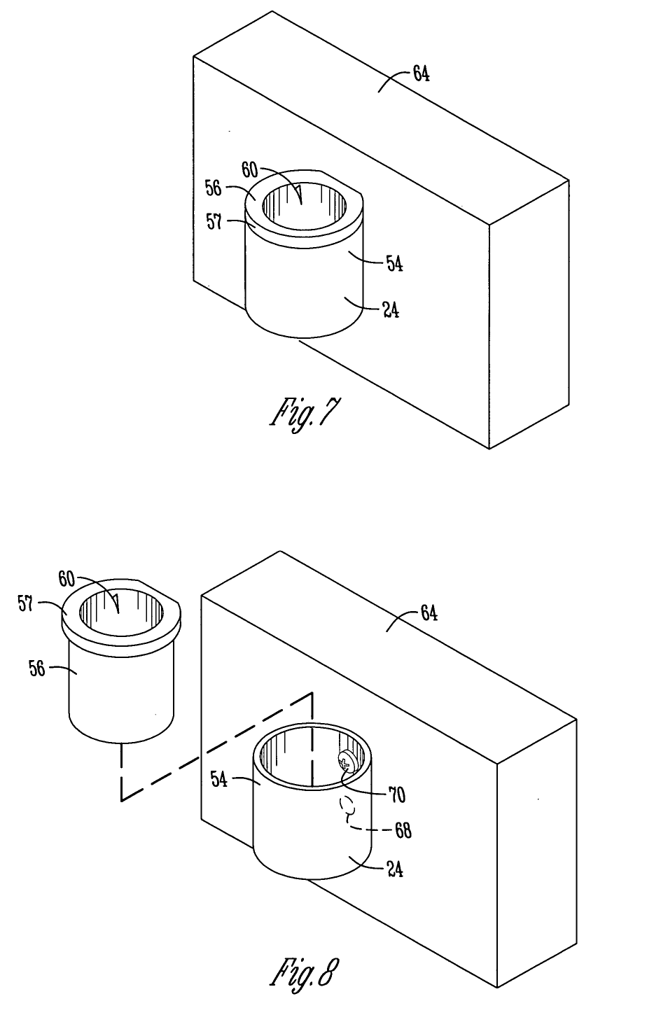

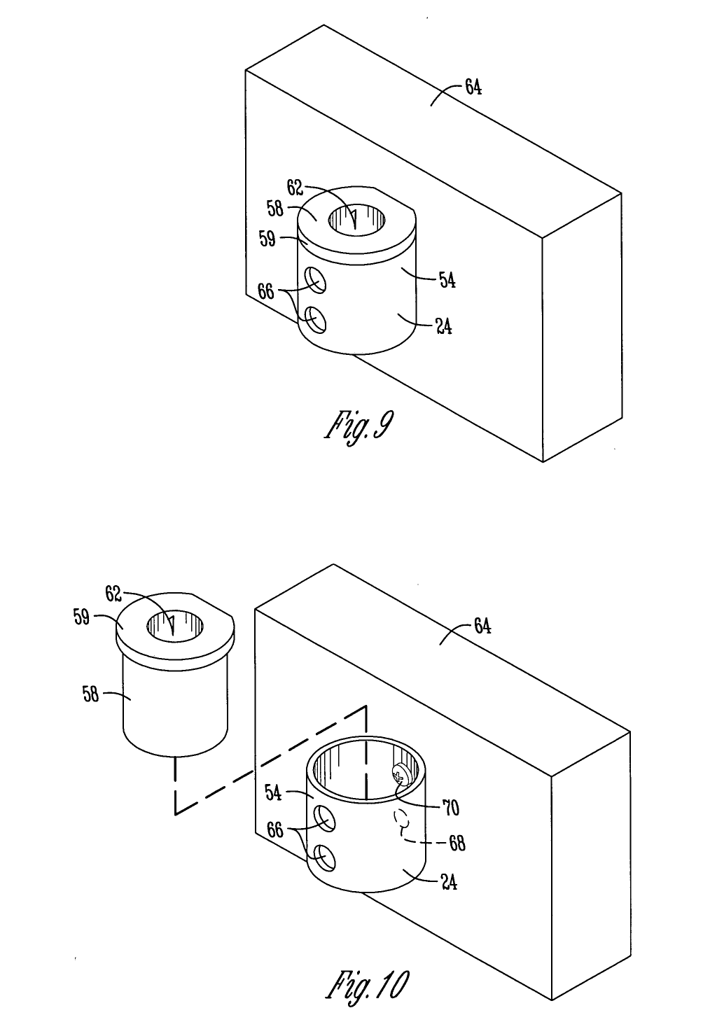

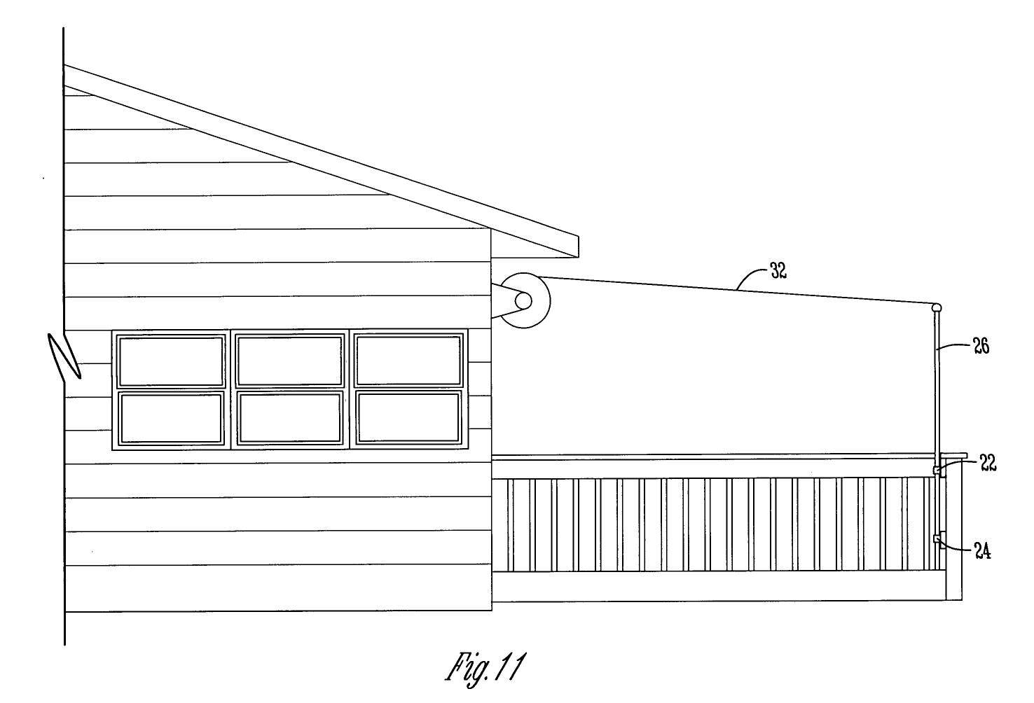

FIGS. 1 and 2 show a deck 10 having a floor 12, a plurality of vertical posts 14 secured to the floor 10 and extending upwardly, with a deck rail 16 connected to the posts 14. The rail 16 includes a facia board 18 and an upper board or sill 20. The construction of the deck 10 is conventional and does not constitute a part of the present invention.

The present invention is directed towards a bracket assembly having an upper bracket 22 and a lower bracket 24, as seen in FIGS. 1 and 2. The bracket assembly is adapt to receive a pole 26 of a deck accessory, such as a tiki torch 28 (FIG. 1) or an umbrella 30 (FIG. 2). It is understood that poles for other accessories may also be mounted to the deck rail 16 using the bracket assembly of the present invention, such as a flag pole, solar lights, a satellite dish, a grill, and a canopy 32 (FIG. 11). It is also to be understood that a cross-section of the pole 26 need not be round, but can be square, have rounded corners.

As seen in FIGS. 3 and 4, the upper bracket 22 has a front plate 34 having an inwardly turned upper lip 36, and inwardly turned lower ledge 38 terminating in an upwardly turned lip 40 which define a rearwardly-open channel for the upper bracket 22. The lower ledge 38 has a width corresponding to the thickness of the facia board 18. The height of the front plate 34 corresponds to the height of the facia board 18 and the thickness of the sill 20. For example, FIGS. 3 and 5 show brackets 22 having different heights. The upper bracket 22 is mounted onto the deck rail 16 by engaging the ledge 38 with the bottom of the facia board 18 and rotating or pivoting the upper lip 36 over the front edge of the sill 20, as seen FIG. 3. Thus, the channel of the upper bracket 22 receives the deck rail 16 so as to mount the bracket 22 on the rail 16 without the use of hardware or tools. The bracket 22 can be slid laterally along the rail 16 to a desired position. Since no screws, clamps, or other hardware is used to mount the upper bracket 22 to the deck rail 16, movement of the bracket 22 along the rail 16, or removal of the bracket 22 from the rail 16, does not leave any holes, indentations, or other blemishes which otherwise would be present from clamps and screws.

The upper bracket 22 also includes a collar 42 which is welded or otherwise secured to the plate 34. The collar 42 has a vertically oriented hole, as best seen in FIG. 4. A first insert 44 and second insert 46 may selectively be inserted into the collar 42 of the upper bracket. Each insert 44, 46 has a vertically oriented hole 48, 50 respectively. The holes in the collar 42, first insert 44 and second insert 46 have progressively smaller diameters so as to accommodate various deck accessories having poles with different diameters. For example, a large diameter pole, such as for the umbrella 30 may be inserted into the hole of the collar 42, without the inserts 44, 46. A smaller diameter pole, such as that on the tiki torch 28 may require either the first insert 44 or the second insert 46 for a snug fit in the collar 42 of the upper bracket 22. The second insert 46 may include an upwardly extending spacer extension 52 which resides between the hole 50 and the front plate 34 so as to provide further stability for the hole 26.

The lower bracket 24 includes a tube or collar 54 with a vertically oriented hole having a diameter matching the diameter of the hole in the collar 42 of the upper bracket 22. Third and fourth inserts 56, 58 may be provided for the lower collar 54, with each insert 56, 58 having a vertically oriented hole 60, 62 respectively, having diameters corresponding to the diameters of the holes 48, 50 of the first and second inserts 44, 46. The lower end of the pole 26 extends through the collar 54 and either of inserts 56, 58 which may be selectively placed in the collar 54, so as to provide enhanced stability for the pole 26.

Preferably, the inserts 44, 46, 56, 58 each include an upper flange 45, 47, 57, and 59, respectively. The flanges 45, 47, 57, 59 engage the upper ends of the respective collars 42, 54 to keep the inserts 44, 46, 56, 58 from falling through the collars. Alternatively, the inserts can be pressed fit into the collars.

The collar 54 is mounted to a block 64. Preferably, the collar 54 includes a pair of front holes 66 and pair of rear holes 68 on opposite sides of the collar. The rear holes 68 are adapted to receive a screw for mounting the collar 54 to the block 64. The front holes 66 allow a screwdriver to extend through the collar 54 for turning the mounting screws 70.

The block 64 has a thickness corresponding to the thickness of the facia board 18 and is adapted to engage one or more of the vertical deck posts 14. Thus, the lower bracket 24 is aligned with the upper bracket 22, without being fixed to the posts 14.

In use, a person simply mounts the upper bracket 22 onto the deck rail 16 with a quick and easy rotational or pivotal action. No hardware or tools are required. The bracket position can be adjusted by sliding the bracket 22 along the rail 16. Then the pole 26 can be inserted into the collar 42 of the bracket 22, with or without one of the inserts 44, 46. The lower end of the pole 26 can then be slid into the lower bracket 24, with or without the inserts 56, 58, as needed. It is understood that the lower bracket 24 is not required for smaller deck accessories having short poles which do not extend to the floor 12 of the deck 10. Rather, such smaller accessories can be supported solely by the upper bracket 22.

The invention has been shown and described above with the preferred embodiments, and it is understood that many modifications, substitutions, and additions may be made which are within the intended spirit and scope of the invention. From the foregoing, it can be seen that the present invention accomplishes at least all of its objectives.

What is claimed is:

1. A bracket assembly for mounting a pole to a deck rail supported on a plurality of vertical posts extending upwardly from a deck floor, the bracket assembly comprising:
a first bracket mountable to the railing without the use of hardware or tools and having a collar with a hole therein;
a first insert having a hole therein;
a second insert having a hole therein;
the holes of the collar, first insert and second insert having progressively smaller diameters;
the first and second inserts being adapted for selective insertion into the collar for receipt of the pole;
whereby the pole extends through the collar for mounting to the deck rail.

2. The bracket assembly of claim 1 wherein the first bracket has an upper lip adapted to overlappingly engage an upper surface of the rail and a lower lip adapted to overlappingly engage a rear surface of the rail.

3. The bracket assembly of claim 1 wherein the first bracket includes a channel to receive the rail.

4. The bracket assembly of claim 1 further comprising a second bracket having a hole, a third insert having a hole, a fourth insert having a hole, the holes of the second bracket, third insert and fourth insert having progressively smaller diameters, the third and fourth inserts being adapted for selective insertion into the second bracket for receipt of the pole, the second bracket being adapted to engage at least one of the vertical deck posts, and whereby the pole extends through the second bracket.

5. The bracket assembly of claim 1 further comprising a second bracket having a hole for receiving the pole at a location below the first bracket.

6. The bracket assembly of claim 5 wherein the second bracket is secured to a block, which is adapted to engage one of the posts so as to align the second bracket with the first bracket.

7. The bracket assembly of claim 6 wherein the second bracket is a tubular collar with front and rear holes extending horizontally through opposite sides of the collar, with the rear hole receiving a screw to secure the collar to the block and the front hole being adapted to receive a screw driver to turn the screw.

8. The bracket assembly of claim 5 wherein the second bracket is supported against a post without attachment to the post.

9. The bracket assembly of claim 5 further comprising third and fourth inserts each having holes of different diameters, the inserts being selectively inserted into the hole of the second bracket whereby the pole extends through the hole of the selected insert.

10. The bracket assembly of claim 1 wherein the bracket is slidable along the rail.

11. A bracket assembly for mounting a pole to a deck rail supported on a plurality of vertical posts extending upwardly from a deck floor, the bracket assembly comprising:
a first bracket having a rearwardly open channel for mounting on the rail without clamping or screwing; and
a collar connected to the first bracket so as to have a vertically oriented hole, and adapted to receive the pole.

12. The bracket assembly of claim 11 wherein the first bracket has an upper lip adapted to overlappingly engage an upper surface of the rail and a lower lip adapted to overlappingly engage a rear surface of the rail.

13. The bracket assembly of claim 11 further comprising a first insert having a hole therein;
a second insert having a hole therein;
the holes of the collar, first insert and second insert having progressively smaller diameters;
the first and second inserts being adapted for selective insertion into the collar for receipt of the pole.

14. The bracket assembly of claim 11 further comprising a second bracket having a hole for receiving the pole at a location below the first bracket.

15. The bracket assembly of claim 14 wherein the second bracket is secured to a block, which is adapted to engage one of the posts so as to align the second bracket with the first bracket.

16. The bracket assembly of claim 15 wherein the second bracket is a tubular collar with front and rear holes extending horizontally through opposite sides of the collar, with the rear hole receiving a screw to secure the collar to the block and the front hole being adapted to receive a screw driver to turn the screw.

17. The bracket assembly of claim 14 wherein the second bracket is supported against a post without attachment to the post.

18. The bracket assembly of claim 14 further comprising third and fourth inserts each having holes of different diameters, the inserts being selectively inserted into the hole of the second bracket whereby the pole extends through the hole of the selected insert.

19. The bracket assembly of claim 11 wherein the first bracket is slidable along the rail.

20. The bracket assembly of claim 11 further comprising a second bracket having a hole, a third insert having a hole, a fourth insert having a hole, the holes of the second bracket, third insert and fourth insert having progressively smaller diameters, the third and fourth inserts being adapted to insertion into the second bracket, for receipt of the pole, the second bracket being adapted to engage at least one of the vertical deck posts, and whereby the pole extends through the second bracket.
